(19) United States
(12) Patent Application Publication
(10) Pub. No.: US 2014/0090565 A1
(43) Pub. Date: Apr. 3, 2014

(54) Buffer Structure of Portafilter

(71) Applicant: KLUB MANUFACTURING CORP., Luju Shiang (TW)

(72) Inventor: Yen-Pin Yang, Jhongli (TW)

(73) Assignee: KLUB MANUFACTURING CORP., Luju Shiang (TW)

(21) Appl. No.: 13/633,855

(22) Filed: Oct. 2, 2012

(51) Int. Cl. A47J 31/06

(52) U.S. Cl. 99/323

(57) ABSTRACT

The present invention relates a buffer structure of portafilter, comprising: an outer shell, having a first space and a second space in the internal thereof; a inner shell, being disposed in the second space and having a third space with at least one passage the internal thereof; a filter, being connected to the outside of the inner shell by a combination unit thereof; a positioning unit, being disposed in the third space and connected to the bottom of the inner shell for supporting; a buffer unit, being disposed in the third space and connected to the positioning unit; an elastic unit, being disposed in the third space, and connected to the buffer unit; and a moveable piston, being connected to the elastic unit.

### BACKGROUND OF THE INVENTION

1. Technical Field

The present invention relates to a portafilter and more particularly to a buffer structure of portafilter for shedding the steam produced during the brewing in the portafilter effectively.

2. Description of Related Art

Coffee machines in the prior art operated according to different principles. The most common models are the so-called pressureless coffee machines. The water flows from a storage container into an electrically heatable pipe. Particularly as a result of the evolution of steam in this pipe, heated water is then pushed through a riser to an outlet via which the heated water then drips into a coffee filter. The filtered coffee can then flow from this coffee filter at atmospheric pressure into a pot.

In contrast, in espresso machines an elevated pressure prevails in the area of the coffee grounds, for example 15 bar. This is achieved by supplying water from a water container or another water supply to an electric-motor-driven pump which then supplies the water at high pressure via an electrically heatable area to a portafilter. This portafilter generally comprises a filter for receiving the coffee. In order to generate the high pressure in the coffee area, during operation the portafilter is located in an area which is sealed towards the atmosphere, which can be designated as a pressure chamber or brewing chamber.

However, the general portafilter includes the shortcomings and drawbacks as follows:

When the portafilter is assembled to the a coffee machine, and the coffee machine is turned on to pour boiling water to the portafilter, in this time the it would also produces the steam, and the boiling water would continue to fill the portafilter until the pressure inside exceed the spring in the portafilter, making the steam and the boiling water shed out of the portafilter. Because the spring has quite high elastic coefficient, the steam produced by boiling water would not shed out until the pressure is achieved. As a result, in the case of the same pressure the amount of water might be less than the expected amount of water, resulting in the bad quality of brewing.

Accordingly, in view of the shortcoming of the conventional stylus, the inventor of the present application has made great efforts to make inventive research thereon and eventually provided an anti-sticking electrosurgical instrument.

### BRIEF SUMMARY OF THE INVENTION

The main objective of the present invention is to use two springs with two different elastic coefficient, making the steam first produced during the brewing would be effectively shed from the first space in outer shell, preventing expected amount of water from reducing, resulting in the bad quality of brewing.

Accordingly, for achieving the above objective of the present invention, the inventors propose a buffer structure of portafilter, comprising:

an outer shell, having a first space and a second space in the internal thereof; a inner shell, being disposed in the second space and having a third space with at least one passage the internal thereof, wherein the third space is connected with the first space through the passage; a filter, being connected to the outside of the inner shell by a combination unit thereof, and covering the passage; a positioning unit, being disposed in the third space and connected to the bottom of the inner shell for supporting, wherein a first through hole is formed in the positioning unit; a buffer unit, being disposed in the third space and connected to the positioning unit, wherein a second through hole is formed in the buffer unit; an elastic unit, being disposed in the third space, and connected to the buffer unit; and a moveable piston, being connected to the elastic unit and against the passage in the third space.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is an appearance view of a first embodiment for a buffer structure of portafilter according to the present invention;

FIG. 2 is an exploded view of the first embodiment for the buffer structure of portafilter according to the present invention;

FIG. 3 is an using diagram of the first embodiment for the buffer structure of portafilter according to the present invention.

FIG. 4 is an appearance view of a second embodiment for a buffer structure of portafilter according to the present invention.

FIG. 5 is an exploded view of the second embodiment for the buffer structure of portafilter according to the present invention.

FIG. 6 is an using diagram of the second embodiment for the buffer structure of portafilter according to the present invention.

### DETAILED DESCRIPTION OF THE INVENTION

To more clearly describe an anti-sticking electrosurgical instrument according to the present invention, embodiments of the present invention will be described in detail with reference to the attached drawings hereinafter:

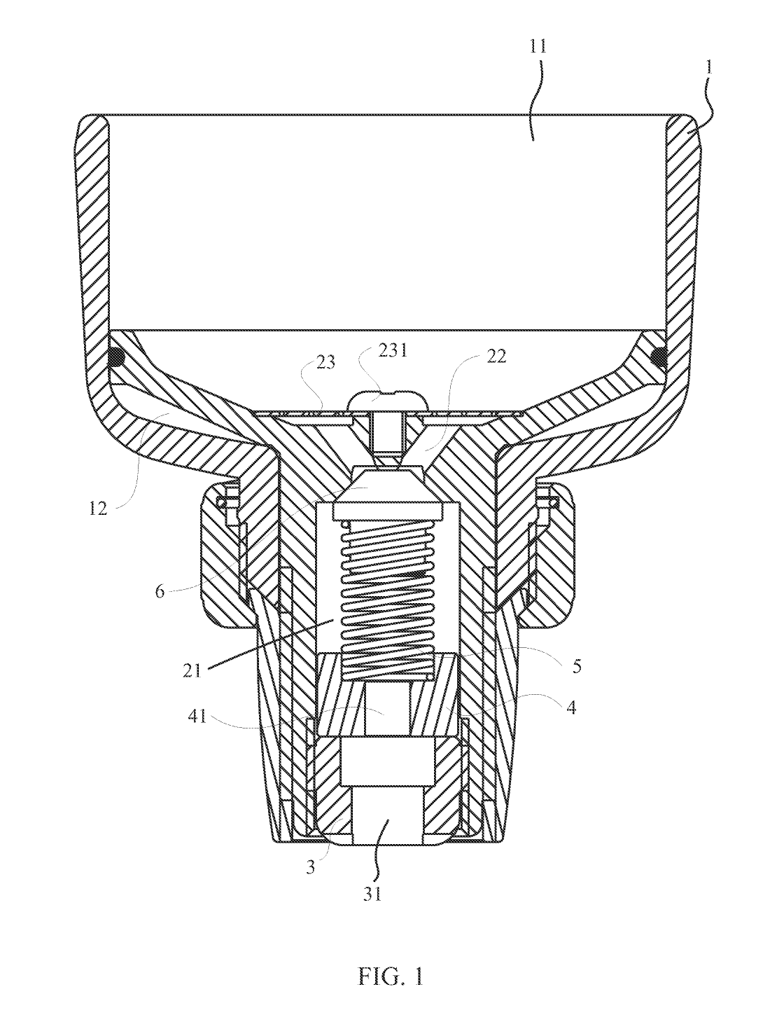

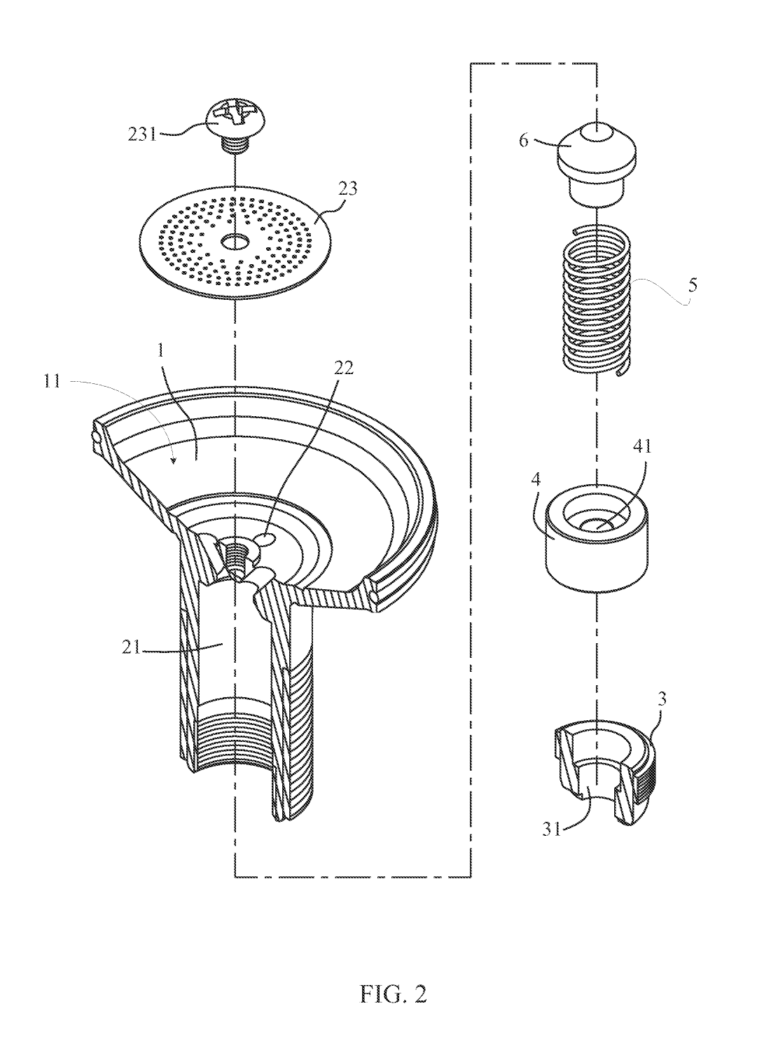

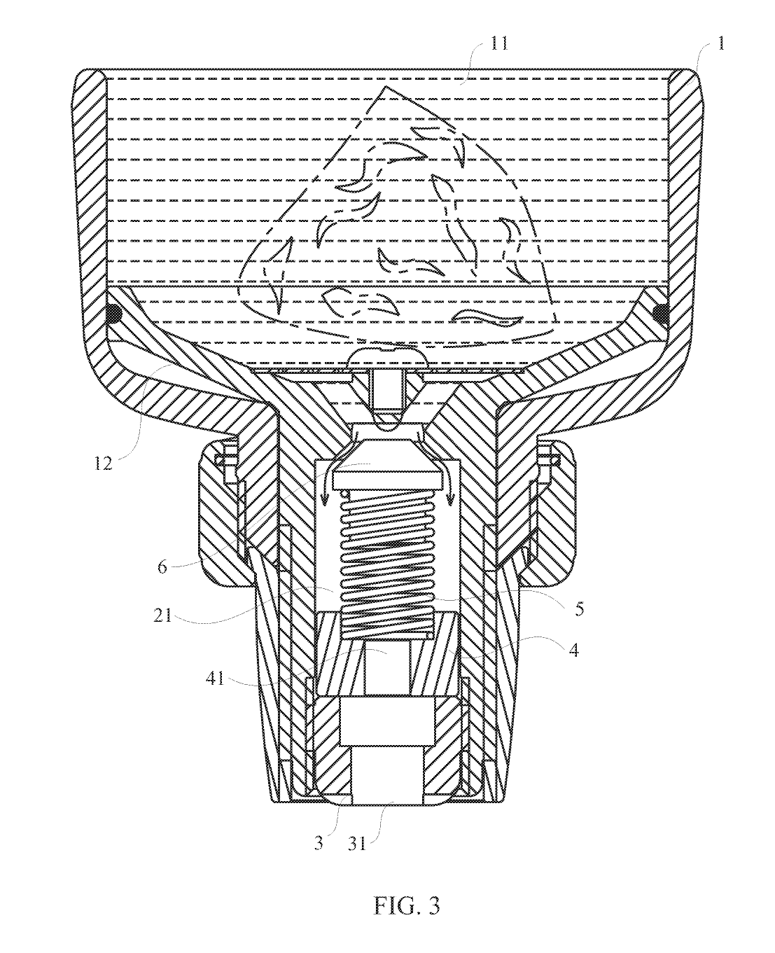

With reference to FIG. 1, FIG. 2 and FIG. 3, there are shown an appearance view, an exploded view, and a using diagram of a first embodiment for buffer structure of portafilter according to the present invention. As shown in FIG. 1 and FIG. 2, the buffer structure of portafilter includes: an outer shell 1, having a first space 11 and a second space 12 in the internal thereof; a inner shell 2, being disposed in the second space 12 and having a third space 21 with at least one passage 22 the internal thereof, wherein the third space 21 is connected with the first space 11 through the passage 22; a filter 23, being connected to the outside of the inner shell 2 by a combination unit 231 thereof, and covering the passage 22; a positioning unit 3, being disposed in the third space 21 and connected to the bottom of the inner shell 2 for supporting, wherein a first through hole 31 is formed in the positioning unit 3; a buffer unit 4, being disposed in the third space 21 and connected to the positioning unit 3, wherein a second through hole 41 is formed in the buffer unit 4; otherwise, the buffer unit 4 is selected from the group consisting of rubber or foam an elastic unit 5, being disposed in the third space 21, and connected to the buffer unit 4, wherein the elastic unit 5 is a series spring combined by two springs with different elastic coefficients.; and a moveable piston 6, being connected to the elastic unit 5 and against the passage 21 in the third space 21, wherein the moveable piston 6 comprises a tapered end portion, and the third space 21 forming with a tapered concave portion corresponding to the tapered end portion, and connecting to the passage 22.

Following description is the explanation for using the buffer structure of portafilter, the steps of method comprises:

Step 1: Putting the coffee powder or tea bag into the first space 21 and assembling the portafilter to a coffee machine or a tea machine.

Step 2: Turn on the coffee machine or tea machine and pour the boiling water into the first space 21;

Step 3: As Shown in FIG. 3, first of all, the first space 21 would be full of steam quickly produced by the boiling water, when the steam pressure exceeds the spring with the lower elastic coefficient, the moveable piston 6 would be pushed away and make the passage 22 unimpeded, resulting the steam in shedding to the third space 21 through the passage 22, then the moveable piston 6 would reply to the situ; and

Step 4: The boiling water is still poured into the first space 11, and brews the coffee powder or tea bag until the water pressure exceeds the spring with the lower elastic coefficient, then the mobile piston 6 would be pushed away and the water would be shed to the third space 21 the passage 22.

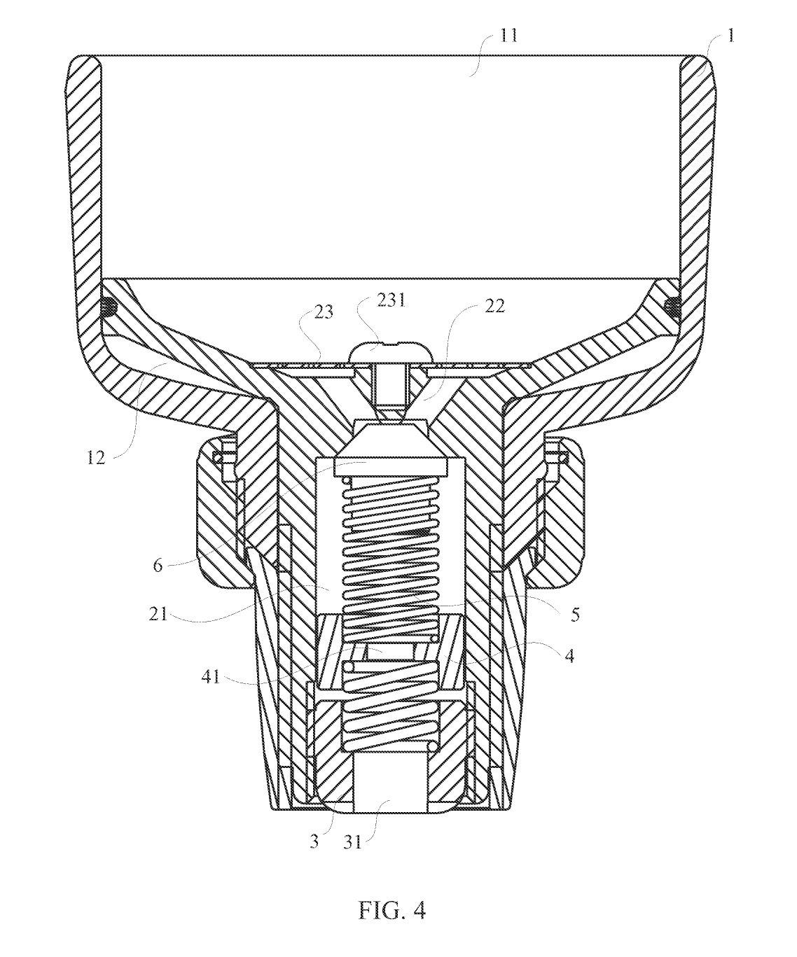

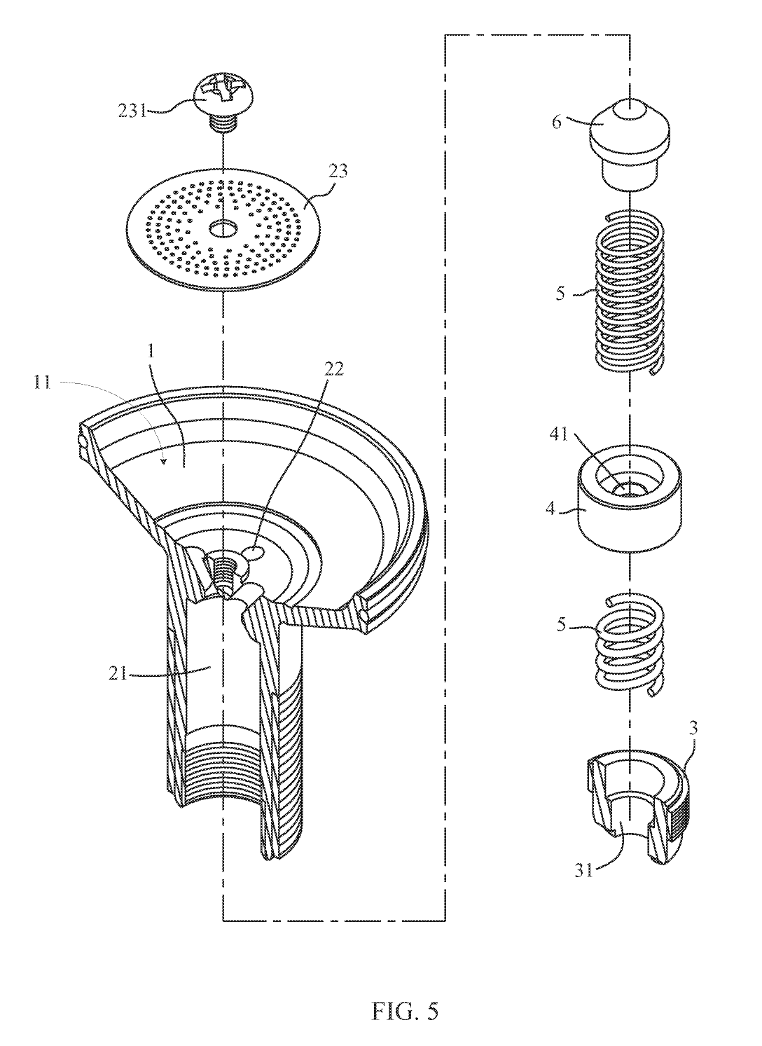

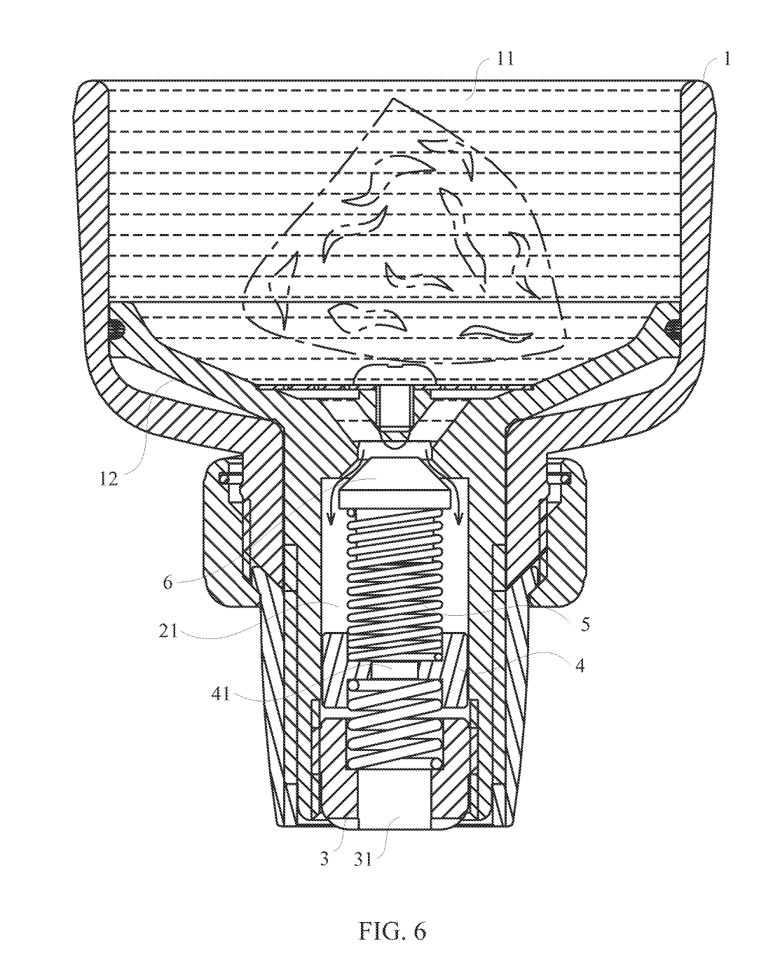

With reference to FIG. 4, FIG. 5, and FIG. 6, there are shown an appearance view, an exploded view, and a using diagram of a second embodiment for buffer structure of portafilter according to the present invention. As shown in FIG. 4, FIG. 5, and FIG. 6, Comparing with the first embodiment, the difference between the first embodiment and the second embodiment is that the elastic unit 5 consists of two springs with different elastic coefficients. So, when the first space 21 is full of steam quickly produced by the boiling water, the steam pressure exceeds the upper spring with lower elastic coefficient, then the moveable piston 6 would be pushed away and make the passage 22 unimpeded, resulting the steam in shedding to the third space 21 through the passage 22, at last the moveable piston 6 would reply to the situ.

In the end, the present invention has been completely and clearly disclosed in the above description, and in summary, the present invention has the following advantage:

By using two springs with two different elastic coefficient, the steam first produced during the brewing would be effectively shed from the first space in outer shell through the passage to the third space, preventing expected amount of water from reducing, resulting in the bad quality of brewing.

The above description is made on embodiments of the present invention. However, the embodiments are not intended to limit scope of the present invention, and all equivalent implementations or alterations within the spirit of the present invention still fall within the scope of the present invention.

I claim:

1. A buffer structure of portafilter, comprising:
an outer shell, having a first space and a second space in the internal thereof;
an inner shell, being disposed in the second space and having a third space with at least one passage the internal thereof, wherein the third space is connected with the first space through the passage;
a filter, being connected to the outside of the inner shell by a combination unit thereof, and covering the passage;
a positioning unit, being disposed in the third space and connected to the bottom of the inner shell for supporting, wherein a first through hole is formed in the positioning unit;
a buffer unit, being disposed in the third space and connected to the positioning unit, wherein a second through hole is formed in the buffer unit;
an elastic unit, being disposed in the third space, and connected to the buffer unit; and
a moveable piston, being connected to the elastic unit and against the passage in the third space.

2. The buffer structure of portafilter of claim 1, wherein the buffer unit is selected from the group consisting of: rubber and foam.

3. The buffer structure of portafilter of claim 1, wherein the elastic unit is a series spring combined by two springs with different elastic coefficients.

4. The buffer structure of a portafilter of claim 1, wherein the elastic unit consists of two springs with different elastic coefficients.

5. The buffer structure of a portafilter of claim 1, wherein the moveable piston comprises a tapered end portion, and the third space forming with a tapered concave portion corresponding to the tapered end portion, and connecting to the passage.
